(19) United States
(12) Patent Application Publication
(10) Pub. No.: US 2003/0184036 A1
(43) Pub. Date: Oct. 2, 2003

(54) Baby walker with improved safety

(76) Inventor: Chi-Fang Wu, Tainen Hsien (TW)

Correspondence Address: Charles E. Baxley, 59 John Street, New York, NY, 10038, US

(21) Appl. No.: 10/109,132

(22) Filed: Mar. 29, 2002

(51) Int. Cl. B62B 7/00

(52) U.S. Cl. 280/87.051

(57) ABSTRACT

A baby walker comprises a lower chassis having a plurality of casters mounted to an underside thereof, an upper chassis mounted above the lower chassis and including a seat, and a supporting device mounted between the upper chassis and the lower chassis for supporting the upper chassis. At least one illuminating element is mounted to at least one of the upper chassis and the lower chassis. A power source supplies electricity to the illuminating element, and a switch controls on/off of the illuminating element.

### BACKGROUND OF THE INVENTION

1. Field of the Invention

The present invention relates to a baby walker comprising an illuminating element for improving safety.

2. Description of the Related Art

FIG. 6 of the drawings illustrates a conventional baby walker comprising an upper chassis 1′, a lower chassis 2′, X-hinged supporting rods 3′ mounted between the upper chassis 1′ and the lower chassis 2′, and plural casters 4′ attached to the lower chassis 2′. A baby may sit in a seat 11′ of the upper chassis 1′ with his/her legs stepping on the ground to move the baby walker in any desired orientation. The upper chassis 1′ includes a toy tray 12′. The upper and lower chassis 1′ and 2′ protect the baby. Since the baby walker often moves at a low speed, falling of the baby walker as a result of impact is rare. However, an adult might run into the baby walker when in the night or in a poor view situation. The present invention is intended to provide a baby walker to solve this problem.

### SUMMARY OF THE INVENTION

An object of the present invention is to provide a baby walker comprising a lower chassis having a plurality of casters mounted to an underside thereof, an upper chassis mounted above the lower chassis and including a seat, a supporting device mounted between the upper chassis and the lower chassis for supporting the upper chassis, at least one illuminating element mounted to at least one of the upper chassis and the lower chassis, a power source for supplying electricity to the illuminating element, and a switch for controlling on/off of the illuminating element.

A transparent cover is provided for covering and thus protecting the illuminating element. The upper chassis includes a toy tray in which the power source is mounted. A controller is provided for controlling illumination of the illuminating element. In an embodiment of the invention, the upper chassis includes a toy tray in which the power source and the controller are mounted. In a modified embodiment of the invention, the power source and the controller are mounted in the upper chassis or the lower chassis. In another modified embodiment of the invention, a sounder is connected to and controlled by the controller. The sounder is mounted in the upper chassis or the lower chassis. In an embodiment of the invention, each of the upper chassis and the lower chassis includes an illuminating element and a sounder mounted thereto. Further, a vibration switch may be used to turn on the illuminating element when the baby walker is subject to vibrations.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view, partly exploded, of a baby walker in accordance with the present invention.

FIG. 2 is a perspective view of the baby walker in accordance with the present invention.

FIG. 3 is a perspective view, partly exploded, of an upper chassis of a modified embodiment of the baby walker in accordance with the present invention.

FIG. 4 is a perspective view, partly exploded, of an upper chassis of another modified embodiment of the baby walker in accordance with the present invention.

FIG. 5 is a perspective view of a further modified embodiment of the baby walker in accordance with the present invention.

FIG. 6 is a perspective view of a conventional baby walker.

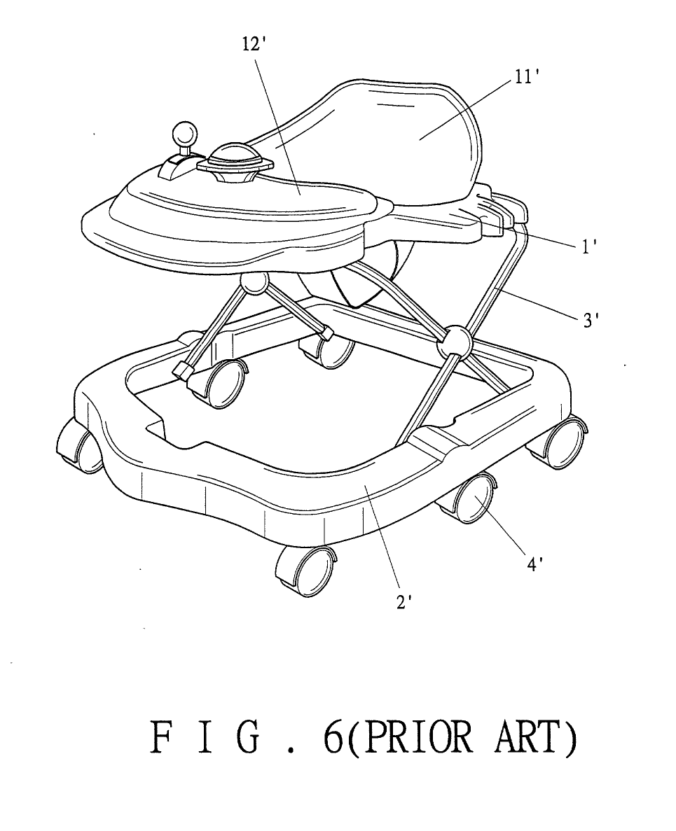

### DETAILED DESCRIPTION OF THE PREFERRED EMBODIMENTS

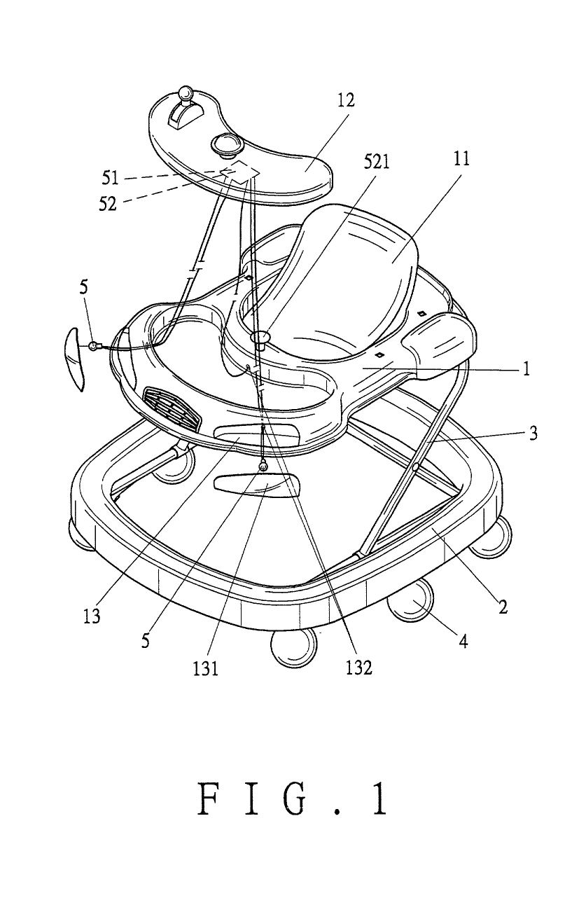

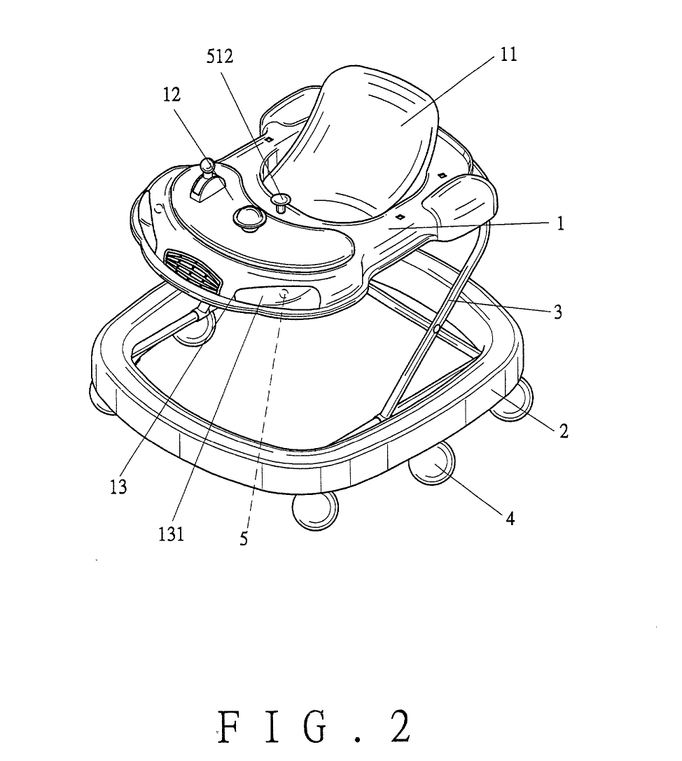

Referring to FIGS. 1 and 2, a baby walker in accordance with the present invention generally comprises an upper chassis 1, a lower chassis 2, a supporting device 3 mounted between the upper chassis 1 and the lower chassis 2 for supporting the upper chassis 1, and plural casters 4 mounted to an underside of the lower chassis 2, allowing the lower chassis 2 to move in any orientation. The upper and lower chassis 1 and 2 are substantially ring-like hollow members. The upper chassis 1 includes a seat 11 and a toy tray 12 on a front end thereof. The lower chassis 2 is connected to the upper chassis 1 through the supporting device 3.

The upper chassis 1 further includes a mounting portion 13 in an appropriate position of an outer periphery of the upper chassis 1. An illuminating element 5 is mounted in the mounting portion 13, and a transparent cover 131 is mounted to cover the mounting portion 13, thereby protecting the illuminating element 5. The toy tray 12 includes through-holes 132 through which wires extend for connecting a power source 51 and a controller 52 mounted in the toy tray 12 to the illuminating element 5. A switch (e.g., a button 521) is provided to control on/off of the illuminating element 5. Further, the controller 52 includes a vibration switch and a control circuit for controlling illumination of the illuminating element 5.

When a baby sits in the baby walker and moves in the night or in a poor view situation, the button 521 is pushed to turn on the illuminating element 5. Thus, people may clearly see the illuminating element 5 and the baby walker, thereby improving safety. Further, the illuminating element 5 provides a decoration.

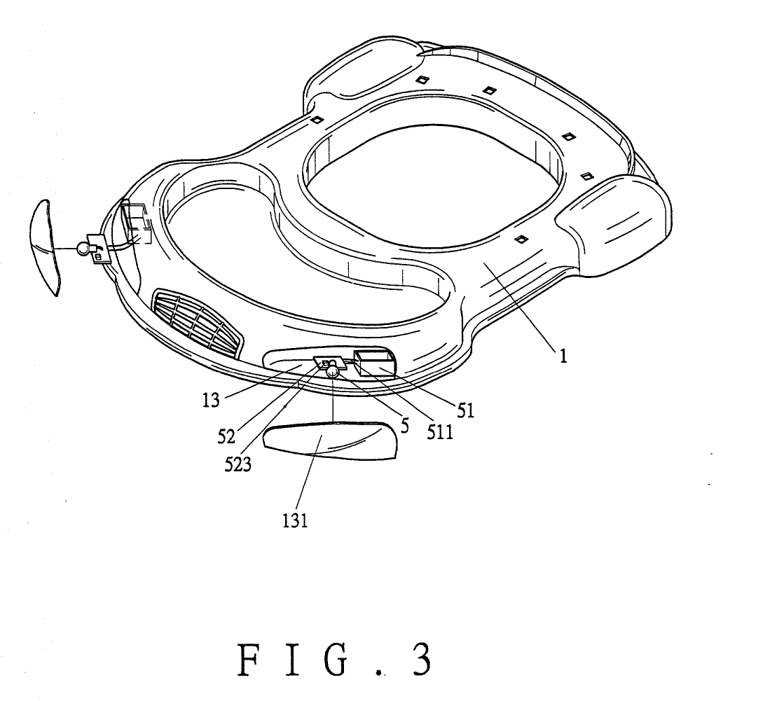

FIG. 3 illustrates a modified embodiment of the invention, wherein the power source 51 and the controller 52 are also mounted in the mounting portion 13 on the upper chassis 1. This allows easier assembly. Further, the controller 52 includes a vibration switch 523 that turns on the illuminating element 5 when the baby walker is subject to vibrations during movement.

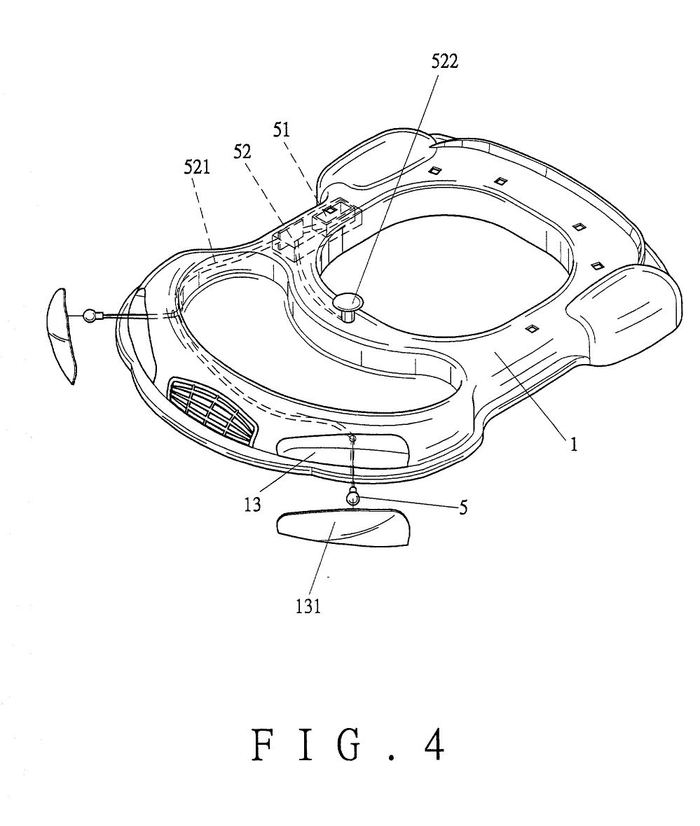

FIG. 4 illustrates another modified embodiment of the invention, wherein the power source 51 and the controller 52 are mounted in the upper chassis 1 in other appropriate positions. Of course, the power source 51 and the controller 52 are electrically connected by wires to the illuminating element 5 for controlling illumination of the illuminating element 5.

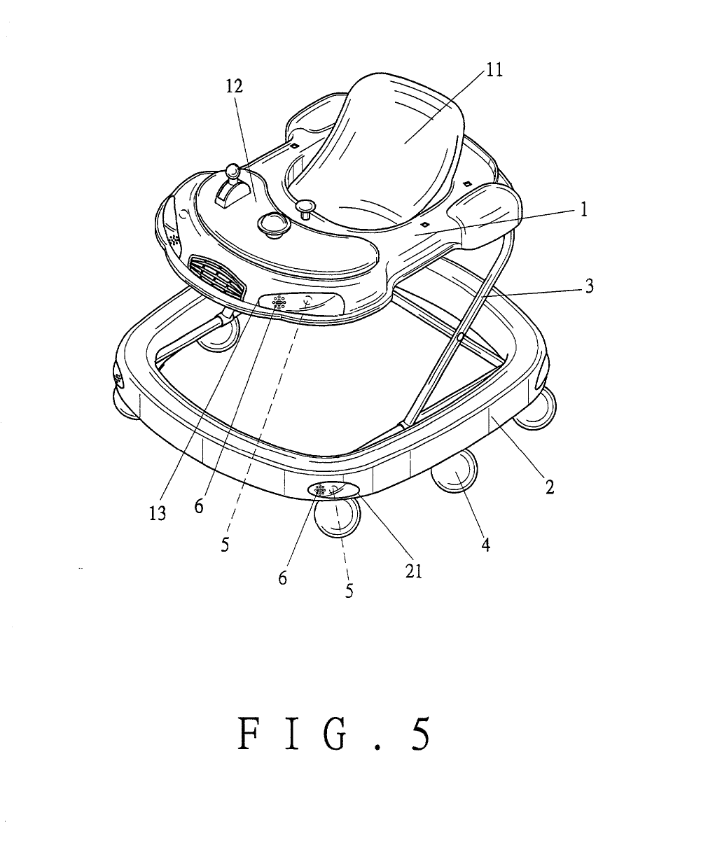

FIG. 5 illustrates a further modified embodiment of the invention, wherein, in addition to the illuminating element 5 in the mounting portion 13 on the upper chassis 1, the lower chassis 2 also includes a mounting portion 21 for receiving another illuminating element 5. Of course, the above-mentioned power source and controller (not shown in FIG. 5) are mounted to an appropriate portion of the upper chassis 1 and/or the lower chassis 2. Further, a sounder 6 (e.g., a loudspeaker) is electrically connected to the power source and the controller. The sounder 6 is mounted to at least one of the mounting portions 13 and 21 of the upper and lower chassis 1 and 2. Thus, the illuminating element 5 is turned on/off and the sounder 6 sounds under the control of the controller. Safety of the baby walker is further improved.

According to the above description, it is appreciated that the baby walker in accordance with the present invention provides improved safety by means of providing an illuminating element together with a switch, a power source, and/or a controller.

Although the invention has been explained in relation to its preferred embodiment, it is to be understood that many other possible modifications and variations can be made without departing from the scope of the invention as hereinafter claimed.

What is claimed is:

1. A baby walker comprising:
a lower chassis having a plurality of casters mounted to an underside thereof;
an upper chassis mounted above the lower chassis and including a seat;
a supporting device mounted between the upper chassis and the lower chassis for supporting the upper chassis;
at least one illuminating element mounted to at least one of the upper chassis and the lower chassis;
a power source for supplying electricity to said at least one illuminating element; and
a switch for controlling on/off of said at least one illuminating element.

2. The baby walker as claimed in claim 1, further comprising a transparent cover for covering and thus protecting said at least one illuminating element.

3. The baby walker as claimed in claim 1, wherein the upper chassis includes a toy tray in which the power source is mounted.

4. The baby walker as claimed in claim 1, further comprising a controller for controlling illumination of the illuminating element.

5. The baby walker as claimed in claim 4, wherein the upper chassis includes a toy tray in which the power source and the controller are mounted.

6. The baby walker as claimed in claim 4, wherein the power source and the controller are mounted in the upper chassis.

7. The baby walker as claimed in claim 4, wherein the power source and the controller are mounted in the lower chassis.

8. The baby walker as claimed in claim 4, further comprising a sounder connected to and controlled by the controller.

9. The baby walker as claimed in claim 8, wherein the sounder is mounted in the upper chassis.

10. The baby walker as claimed in claim 8, wherein the sounder is mounted in the lower chassis.

11. The baby walker as claimed in claim 1, further comprising a vibration switch for turning on the illuminating element when the baby walker is subject to vibrations.
